(19) United States
(12) Patent Application Publication
(10) Pub. No.: US 2023/0086473 A1
(43) Pub. Date: Mar. 23, 2023

(54) SMART RETRY POLICY FOR AUTOMATED PROVISIONING OF ONLINE RESOURCES

(71) Applicant: Cisco Technology, Inc., San Jose, CA (US)

(72) Inventors: Vicky Deliwala, Morrisville, NC (US); Yatin Wadhavkar, Cary, NC (US); Seshagirirao Surapaneni, Folsom, CA (US)

(21) Appl. No.: 17/479,035

(22) Filed: Sep. 20, 2021

(51) Int. Cl. H04L 12/911; H04L 12/923; H04L 12/24

(52) U.S. Cl. CPC H04L 47/745; H04L 47/762; H04L 47/781; H04L 41/0631; H04L 41/0627; H04L 41/0654

(57) ABSTRACT

In one embodiment, an illustrative method herein may comprise: determining, by a device, that a request for an online resource has not yet provisioned the online resource; determining, by the device, one or more errors responsible for the online resource not yet being provisioned; determining, by the device, whether the one or more errors have since been resolved; retrying, by the device and in response to the one or more errors having since been resolved, the request for the online resource to be provisioned; and deferring, by the device and in response to the one or more errors remaining unresolved, an attempt to request that the online resource be provisioned.

### TECHNICAL FIELD

The present disclosure relates generally to computer systems, and, more particularly, to a smart retry policy for automated provisioning of online (e.g., cloud) resources.

### BACKGROUND

Resource provisioning in cloud computing is an on-demand way to conveniently access a shared pool of configurable network resources (e.g., servers, CPUs, storage, etc.), through techniques such as static allocation in advance or dynamic allocation as needed (e.g., pay-per-use). Some of the benefits of cloud computing include such things as guaranteed performance, selection and deployment of resources as-needed, and runtime management of software and hardware resources. Cloud computing, in particular, addresses many customer Quality of Service (QoS) needs, such as availability, reliability, security, response time, and cost effectiveness.

Examples of online resources include virtual machines (VMs) allocated to certain processes, user terminals, storage facilities, and so on. Procuring a complete cloud infrastructure for certain services, however, can be heavily dependent on multiple micro services. The increase in complexity can often cause temporary service interruptions, transient faults, and so on, resulting in manual intervention by clients for resolution such as performing a retry” operation (attempting to request the provisioning of online resources again after a failure). This renders a poor user experience due to the frequent retry operations and the uncertain wait times to eventually (hopefully) procure cloud resources. Service providers, in particular, need to handle unnecessary system load, inefficient resources utilization, and unstable states of their systems, making it difficult to meet QoS and service-level agreements (SLAs), which are two of the utmost parameters in cloud computing.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example of a lifecycle for procurement application programming interfaces (APIs);

FIG. 5 illustrates an example flow chart for embedding preventive monitoring to predict failure paths in online resource procurement;

FIG. 6 illustrates an example high-level system design for an automated retry is mechanism including customized error categories (“buckets”);

FIG. 7 illustrates a more detailed example of an automated retry mechanism (e.g., through a scheduled operation/“Cron job”);

FIGS. 8A-8C illustrate an example of intelligently persisting infrastructure on failures by cleaning up stale resources;

FIG. 9 illustrates an example simplified procedure for providing a smart retry policy for automated provisioning of online (e.g., cloud) resources in accordance with one or more embodiments described herein; and

FIG. 10 illustrates another example simplified procedure for providing a smart retry policy for automated provisioning of online (e.g., cloud) resources in accordance with one or more embodiments described herein, particularly regarding partially successful requests.

### DESCRIPTION OF EXAMPLE EMBODIMENTS

### Overview

According to one or more embodiments of the disclosure, an illustrative method herein may comprise: determining, by a device, that a request for an online resource has not yet provisioned the online resource; determining, by the device, one or more errors responsible for the online resource not yet being provisioned; determining, by the device, whether the one or more errors have since been resolved; retrying, by the device and in response to the one or more errors having since been resolved, the request for the online resource to be provisioned; and deferring, by the device and in response to the one or more errors remaining unresolved, an attempt to request that the online resource be provisioned.

In another embodiment, the request for the online resource further requested is additional online resources, and one or more of the additional online resources were successfully provisioned while the online resource was not yet provisioned, and the method further comprises: persisting the one or more additional online resources that were successfully provisioned during retrying and deferring.

In another embodiment, the method further comprises: configuring a plurality of possible error categories for a given implementation, wherein the one or more errors responsible for the online resource not yet being provisioned fall into one or more respective error categories of the plurality of possible error categories; and wherein determining whether the one or more errors have since been resolved is based on determining whether the one or more respective error categories have since been resolved.

In still another embodiment, the method further comprises: anticipating a provisioning failure of the online resource in response to the request for the online resource; and preventing the request for the online resource from attempting to provision the online resource in response to anticipating a provisioning failure, wherein the request for the online resource has not yet provisioned the online resource due to the preventing.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

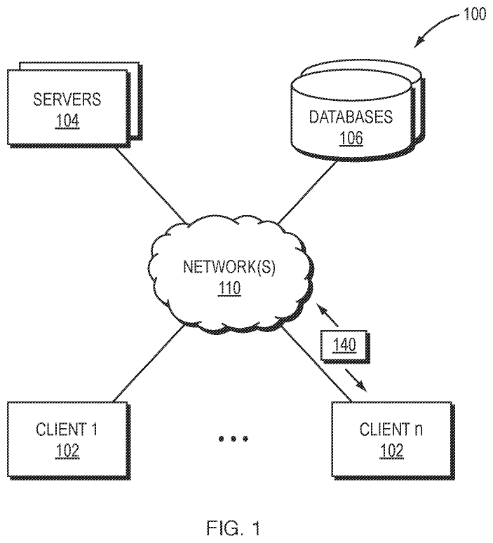

FIG. 1 is a schematic block diagram of an example simplified computing system 100 illustratively comprising any number of client devices 102 (e.g., a first through nth client device), one or more servers 104, and one or more databases 106, where the devices may be in communication with one another via any number of networks 110. The one or more networks 110 may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, is smart televisions, Internet of Things (IoT) devices, autonomous devices, or any other form of computing device capable of participating with other devices via network(s) 110.

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and is databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

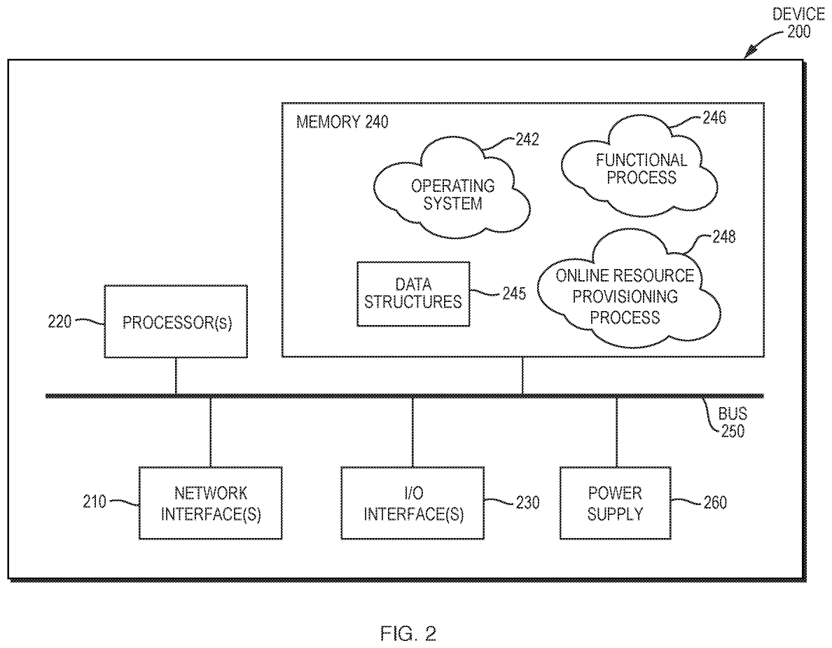

FIG. 2 is a schematic block diagram of an example node/device 200 that may be used with one or more embodiments described herein, e.g., as any of the devices 102-106 shown in FIG. 1 above. Device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are is typically resident in memory 240 and executed by the processor, functionally organizes the device by, among other things, invoking operations in support of software processes and/or services executing on the device. These software processes and/or services may comprise a one or more functional processes 246, and on certain devices, an illustrative “online resource provisioning” process 248, as described herein. Notably, functional processes 246, when executed by processor(s) 220, cause each particular device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

—Observability Intelligence Platform—

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be is implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more embodiments herein may thus be based on (or otherwise relate to or utilize) an observability intelligence platform for network and/or is application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

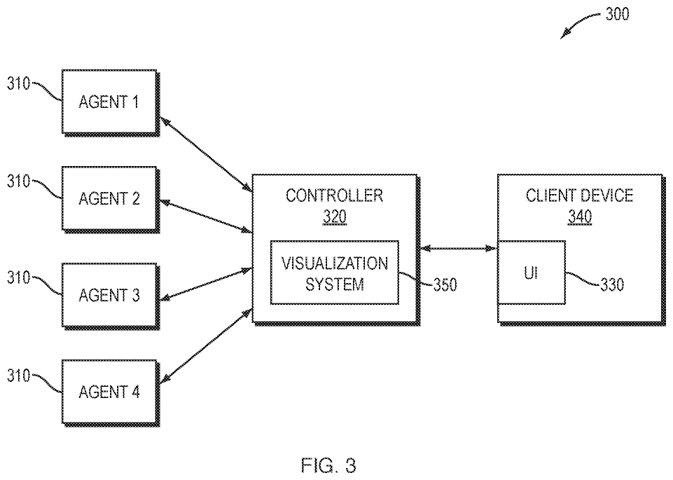

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or is run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable embodiment of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents 310 and one or more servers/controllers 320. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller(s) 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe is packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) 330 that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, a controller instance 320 may be hosted remotely by a provider of the observability intelligence platform 300. In an illustrative on-premises (On-Prem) implementation, a controller instance 320 may be installed locally and self-administered.

The controllers 320 receive data from different agents 310 (e.g., Agents 1-4) deployed to monitor networks, applications, databases and database servers, servers, and is end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain embodiments, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., is associating the business transaction with a 4-tuple of a source IP address, source port, destination IP address, and destination port). A flow map can be generated for a business transaction that shows the touch points for the business transaction in the application environment. In one embodiment, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain embodiments, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

—Smart Retry—

As noted above, resource provisioning in cloud computing is an on-demand way to conveniently access a shared pool of configurable network resources (e.g., servers, CPUs, storage, etc.), through techniques such as static allocation in advance or dynamic allocation as needed (e.g., pay-per-use). As a non-limiting example, service providers may provide Load Testing as a Service (LTaaS) to load test a system's performance under real-life load conditions. LTaaS is often a self-service (e.g., running load tests using automated scripts from available tools) and uses procured resources (e.g., virtual machines/VMs), such as on an OpenStack platform with on-demand pricing. Note also that LTaaS may be a type of platform as a service (PaaS), illustratively utilizing an API-driven cloud infrastructure lifecycle.

For instance, in this illustrative example, a cloud infrastructure manager may create a Group to manage authorization of resources, may secure associated funds, and creates the corresponding tenant. To procure the Load Test (LT) resources, a user interface (UI) allows an admin to select a flavor based on the anticipated user load, such that RESTful APIs are executed, and VM details are sent (e.g., via email). Accordingly, Load Testing may be performed by creating scripts to execute load tests, allowing review of unified performance reports across the tests. (Note that at the completion of the tests, LT resources may be decommissioned, e.g., modifying/deleting resources based on need, such as by executing RESTful APIs).

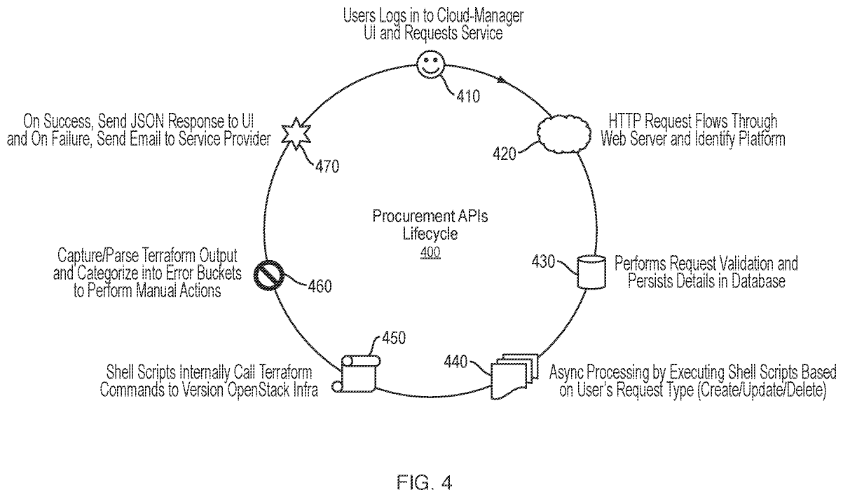

FIG. 4 illustrates an example of a lifecycle 400 for procurement APIs. In particular, first in stage 410, a user (e.g., admin) logs in to a portal UI (e.g., CloudManager) and requests a service (e.g., the illustrative Load Testing Service above). In stage 420, the resultant HTTP Request flows through the appropriate Web Server and Identity platform, which in stage 430 performs request validation and persists the request details in a corresponding database. Async processing is performed in stage 440, such as by executing Shell scripts based on the user's request type (e.g., create, update, delete, etc.). Note that in stage 450, the shell scripts may internally call certain commands (e.g., Terraform commands) to version an infrastructure (e.g., an OpenStack Infrastructure). Subsequently, in stage 460, the output from stage 450 (e.g., the Terraform output) may be captured/parsed and categorized into individual “Error buckets” (described below) to perform actions according the error type (e.g., traditionally manually). Stage 470 depends on success or failure of the procurement of desired resources, where upon success, the response (e.g., a JSON response) may then be sent to the UI, whereas upon failure, a report (e.g., email) may be returned to the admin and/or to the associated service provider.

As noted above, however, RESTful APIs to procure the cloud infrastructure for certain services (e.g., the example Load Testing service) are often heavily dependent on multiple micro services, which can cause temporary service interruptions, transient faults, is and client's manual intervention for resolution, rendering poor user experience. Traditional systems immediately generate failure messages on the UI, and do not persist any “partial successes” (i.e., rolling back to previous states), forcing customers to perform retry operations frequently, resulting in experiencing uncertain wait times to procure cloud resources. In addition to client/customer limitations, service providers also experience unnecessary load on the system, inefficient resource utilization, longer resolution time, unstable state of the system, and significant manual intervention. It is also difficult for service providers to meet QoS and SLA terms, key parameters in cloud computing.

The techniques herein, therefore, provide for a smart retry policy for automated provisioning of online (e.g., cloud) resources. In particular, the embodiments herein present a smart solution for seamless infrastructure (“Infra”) procurement, which identifies and handles probable faults and provides custom error buckets, and also accurately predicts the failure paths, thus applying a retry strategy intelligently by embedding such preventive monitoring. The techniques herein also intelligently persist infrastructure on errors/failures, hiding temporary exceptions, and cleaning up stale resources as needed.

Operationally, and as described below, key elements of the smart retry solution herein may comprise a) preventive monitoring for predictions, b) customizable error buckets, c) persisting existing infrastructure on failures, and d) automated clean-up of stale resources.

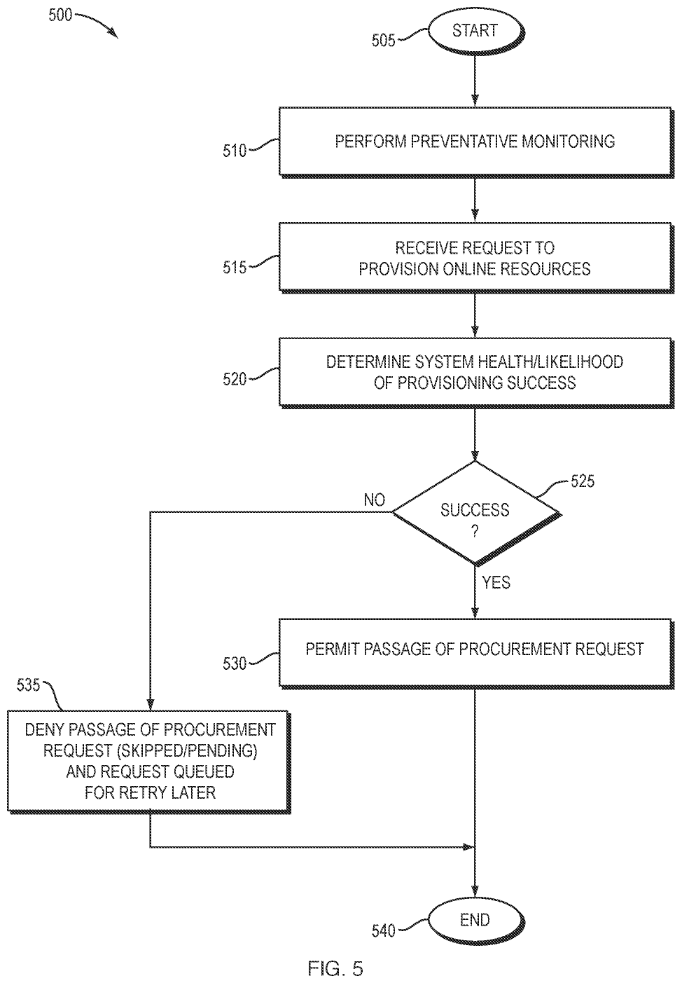

First, and with reference to the simplified flowchart 500 of FIG. 5, the techniques herein are configured to handle probable faults by embedding preventive monitoring to predict the failure paths. In particular, the flowchart starts in step 505, and continues to step 510 where preventative monitoring is performed, such as by the observability intelligence platform above, or any other observability techniques (e.g., locally performed, or performed by a remote observability platform). That is, software defined instrumentation at a number of custom-defined error categories (defined below) helps to generate precaution notifications, such that any fault identifications or other proactive is findings can be used to intelligently identify any failure paths/scenarios beforehand in order to take the necessary precautions to minimize system downtime and overutilization of resources.

Specifically, upon receiving a request to provision online resources (e.g., VMs) in step 515, the system herein can use these notifications to accurately identify and predict the failure paths by taking more proactive approach to determining system health in step 520, and thus a likelihood of provisioning success. For example, as described in greater detail below, if the answer in step 525 is likely success (e.g., no errors, no limitations, etc.), then in step 530 the procurement request is permitted to pass. However, if any indication of health may (or would) imply that a request would likely be denied anyway (e.g., 75% CPU utilization, resource quota exhausted, etc.), then in step 535 passage of the procurement request is denied. That is, in step 535, the request may be queued into a skipped/pending status for retry later, as detailed further below.

In this way, by making this resource availability determination ahead of time (e.g., executing an Openstack API before each create/update call) to identify the system's health, the techniques herein can then only provision resources when they are available, and may wait otherwise to try later (e.g., for a down system to come back online, for poor performance to improve, for a quota exhaustion flag to be removed, etc.). The illustrative simplified procedure ends in step 540.

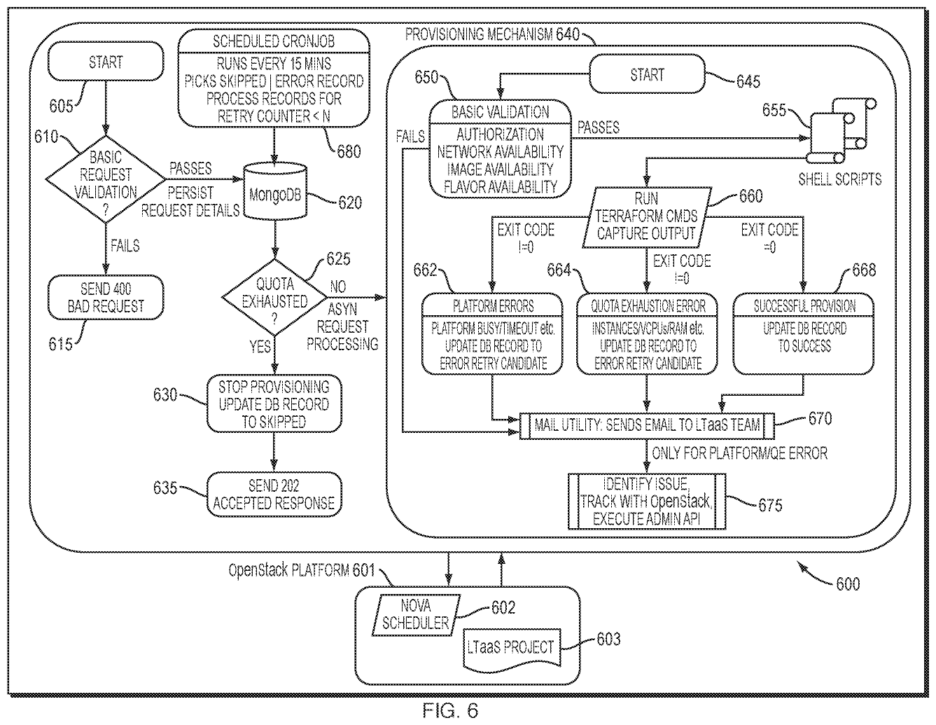

Events such as throttle limits, connection failures, platform specific issues, quota exhaustion (QE), power outage, authorization problems, etc. can lead to unwanted transient faults. To handle such faults gracefully, the techniques herein provide custom error categories (or “buckets) which allow the provider to configure and categorize temporary service interruptions programmatically. Specifically, based on these categories (buckets), respective reactive actions may be taken to better utilize cloud resources, as shown and described below in FIG. 6. For instance, depending on the type of error, the techniques herein may stop the provisioning, update a database record to classify the failed task as a retry candidate, and so on.

Though such categories (buckets) may be configured as needed, examples may include:
1) Platform Errors (e.g., down/slow);
2) Quota Exhaustion Errors (e.g., CPU cores/RAM/VMs/etc.);
3) Service API Errors (e.g., throttle limits, connection failures, expired certificates, etc.); and
4) Network-bound Errors (authorization, network/image/flavor availability).

FIG. 6, in particular, illustrates an example high-level system design 600 for an automated retry mechanism herein utilizing the error buckets mentioned above. In particular, a platform, such as the illustrative OpenStack Platform 601, may be desirous of allocating online resources, such as through an illustrative Nova scheduler 602 (a service that selects particular compute nodes on which to run a given instance of a service) and for a cloud compute infrastructure such as the illustrative LTaaS project 603 mentioned above.

The general system starts in step 605 upon receiving a request to procure/provision online resources. The techniques herein first determine whether basic request validation would pass in step 610, such as according to the first error categorization/bucket (e.g., is the request authorized, is the network available, etc.). If the validation would fail, then in step 615 the system simply sends an error, such as an HTTP 400 Bad Request response status code (indicating that the server cannot or will not process the request due to something that is perceived to be a client error).

When the basic request validation should pass, the system persists the requests details in step 620 in a database, such as in a MongoDB database. The system then checks whether a quota exhausted error has been reached, meaning whether the requestor has already used all of their allocatable resources, such as for a given time (e.g., 20 VMs monthly) or at a time (e.g., 20 VMs maximum at any time), and so on. If the quota is is exhausted (notably determined prior to actually forwarding the provisioning request to the provisioning mechanism 640), then in step 630 the system stops provisioning and updates the database record to indicate that this particular request was skipped. Then, in step 635, the system may send an appropriate message back to the requestor, such as an illustrative HTTP 202 Accepted response (indicating that the request has been accepted for processing, but the processing has not been completed, and that the request might or might not eventually be acted upon).

If the basic request validation is believed to pass, and the quota is not known to be exhausted, then the provisioning mechanism 640 is officially invoked. Provisioning, in particular, starts in step 645 with the provisioning/procurement request for online (e.g., cloud) resources, and continues to step 650 where the actual basic validation takes place, checking for such things as general authorization, network availability, image availability, flavor availability, and so on. Assuming the initial prediction was correct and the basic validation passes, then shell scripts 655 are used to execute commands in a command line interface (CLI), such as Terraform commands, such that the output can be captured and correspondingly parsed.

The output, in particular, may be associated generally with a pass/fail status, illustratively shown as either a non-zero “exit code” detailing a specific error (e.g., exit code !=0), or else a success (e.g., exit code=0). In particular, on faults, various categories of errors (further “buckets”) may include errors relating to platform errors 662, quota exhaustion errors 664, etc., while a successful provision 668 results in updating the database record to a success, accordingly. The faults, on the other hand, may be handled appropriately (e.g., based on their respective category), according to the techniques herein. For instance, platform errors 662, such as platform busy, timeout, etc., may be logged by updating the database record to an error and as a retry candidate, specifically once the corresponding platform error has resolved, as described below. Similarly, quota exhaustion errors 664 such as instances, VCPUs, RAM, etc., may similarly be logged as a retry candidate for when such errors are resolved.

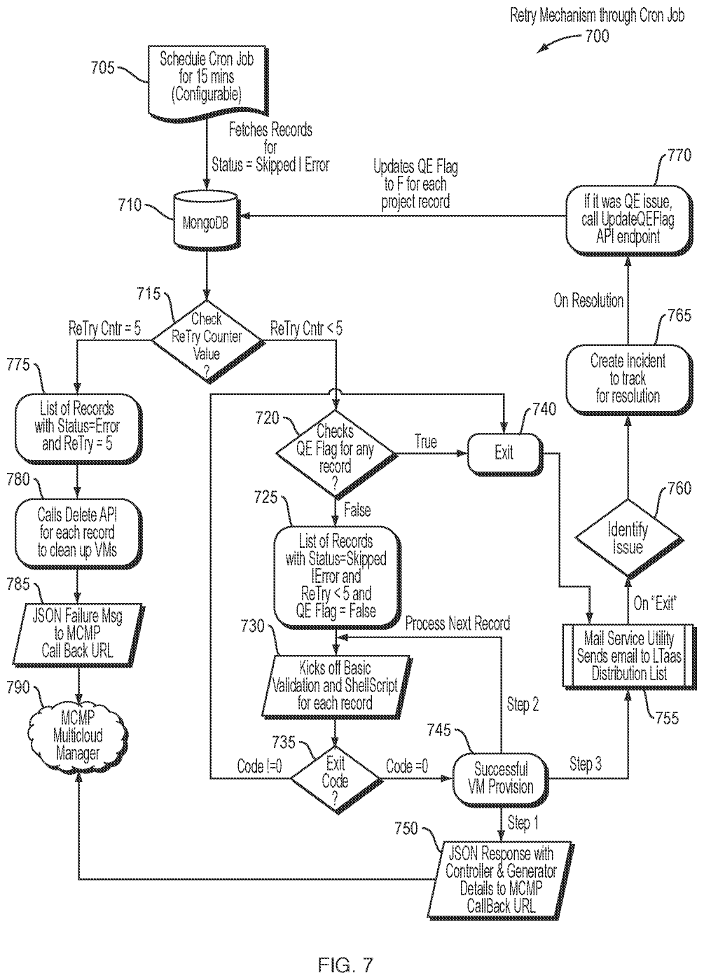

Results from the provisioning mechanism 640 may be shared via a mail utility 670 (or other interface, such as a UI), such as sending an email to the requesting team (e.g., the illustrative LTaaS team). Thereafter, according to the techniques herein, for any categorized errors (e.g., platform errors, quota exertion errors, etc.), the provisioning mechanism 640 identifies the issues, tracks them (e.g., with OpenStack), and executes an admin API, all shown collectively in step 675, which, in combination with the “scheduled cronjob” 680, creates a profound retry strategy, which is described in greater detail below in FIG. 7. For instance, and as described in greater detail below, the identified issues (675) are used by the periodic cronjob (scheduled tasks) (680) to pick errored out records, and for a maximum “N” number of attempts (e.g., 5 attempts), processes the records for retry attempts once the categorical issues have been resolved. (Note that as shown, the failure prediction of the basic request validation 610 need not, though may, be performed as part of a retry, since in general, it may be assumed that if the basic validation has once passed, it will pass again.)

Note that in one embodiment, pre-instrumentation of the possible errors (e.g., platform errors, network errors, etc.) may also take place prior to submitting a request to the provisioning mechanism 640. That is, in addition to basic request validation 610 and quota exhaustion 625, the techniques herein may also initially (i.e., prior to any errors) make a predictive determination as to whether any such errors may occur, and to enter such requests into a “skipped” queue, as well. Otherwise, in another embodiment, procurement is attempted to first determine any errors/failures, and then retries occur after resolution of such errors/failures, accordingly.

According to one or more embodiments of the present disclosure, as mentioned above, FIG. 7 illustrates more details for a configurable retry mechanism through a cronjob that is scheduled to run at a regular interval (e.g., 15 minutes) to re-attempt provisioning of the Pending (e.g., errored) and Skipped records which are marked as a retry candidate above. Specifically, this algorithm identifies and processes the incomplete requests by intelligently retrying, but only if the underlying faults have been resolved. This avoids any manual intervention to recognize and retry the failed requests repeatedly, hence making the system stable without any unnecessary load. Furthermore, instead of merely displaying error messages in the event of any underlying faults, the techniques herein queue the incoming requests and processes them later once the system is up and running (i.e., once the underlying cause(s) of the faults has/have been resolved).

The automated retry mechanism 700 herein shown in FIG. 7, in particular, specifically starts in step 705 on a periodic schedule (a “cron job”), such as every 15 minutes or other configurable value. For instance, the system first fetches records whose status is “Skipped” or “Error”, etc., as described above, from the database (e.g., MongoDB) in 710. In step 715, the techniques herein then determine whether a maximum (configurable) number of retries has already been reached, that is, by checking a retry counter value, such as to determine if the value is less than or equal to “N” above (e.g., 5 in this example).

Assuming there are still retry attempts available, the system proceeds to step 720 to check the quota exhausted (QE) flag for any record, where a “true” record indicates that the quota is exhausted, and where a “false” record indicates that the quota is not exhausted. In the latter case where the quota is not exhausted, in step 725 the system herein now has a list of records whose status is either “skipped” or “error”, a retry count less than “N” (e.g., 5), and a QE flag that indicates the quota is not exhausted (e.g., “false”). As such, the techniques herein may begin basic validation and ShellScript action for each record in this list (retry candidates) in step 730. (Note that a cleared QE flag may be the first resolution of a previous reason for skipping a particular request, and thus this check passes the first hurdle toward a successful provisioning for such records, accordingly.)

In the event of a non-zero error code (i.e., an error) in step 735, or else if in step 720 there is a still an exhausted quota, then the retry attempt exits in step 740. However, if there is no error, then in step 745 the online resource provisioning (e.g., VM provision) is successful. If so, then the system may submit a JSON respond with controller and generator details to the multi-cloud manager platform (MCMP) 790 (to a callback URL) is in step 750, and also processes any additional skipped or pending records in step 730. Once all retry records are processed (successfully in step 745 or on an exit/error in step 740), then in step 755 a report may be generated for consumption, such as a mail service utility as shown sending an email to a distribution list (e.g., the LTaaS project team, in the illustrative example herein).

For instances where an exit (step 740) from the retry occurs, in step 760 the techniques herein identify the particular issue causing the exit. That is, as described above, the error may be classified into one or more particular error categories/buckets. These error categories may then be used to create incidents to track for resolution in step 765, meaning monitoring, instrumenting, or otherwise determining whether the issue(s) has (have) been resolved before proceeding. For example, if the issue was a QE Flag being set, the system monitors for clearing of the flag. If the issue was a platform over-utilization error (e.g., CPU>75%), then the system may wait until the utilization error clears (e.g., CPU<75%, or for buffering CPU<50%, and so on).

Upon resolution, the retry mechanism herein may proceed to process an additional retry of the resource provisioning, assuming the retry counter value hasn't yet reached its maximum. Note that if the issue was a quota exertion issue that was resolved, it may be beneficial (or required) to call an UpdateQEFlag API endpoint (reset/update the QE flag to “F”/“false” for each project record in the database) in step 770 before moving on.

Note that the resolution check for a particular known error cause (step 765) may be performed on the first retry attempt as well, and not merely after another error as may be assumed from the order of FIG. 7. That is, the techniques herein may know the particular error category for a particular skipped/errored online resource, and prior to step 730 (and notably any step ahead of step 730) may first determine if such an error condition has been resolved according to the instrumentation as described herein. In other words, while quota exhaustion resolution is explicitly shown herein, other errors may also be checked against prior to retrying a particular resource provisioning.

Once the retry counter is maximized in step 715, then in step 775 there is a list of is records with their status as “error” and a retry count maximized (e.g., 5). As such, the techniques herein may call a delete API (e.g., a delete RESTful API) for each record to clean up the unused and incompletely provisioned resources (e.g., VMs) on the cloud platform as well as from the database in step 780, prior to sending a JSON failure message to the MCMP 790 (to the callback URL) in step 785.

Note that the techniques herein intelligently persist infrastructure on failures during the cleaning up of the stale resources. That is, the techniques herein acutely persist already procured compute resources in the event of any failures, where for any Update operation above, if the underlying Asynchronous request fails to procure the requested resource, then the proposed strategy will lock the state file, identify the current state of the system, and would roll back to the last known working state by cleaning up any stale resources, accordingly.

According to the techniques herein, therefore, by integrating unique statuses like Pending and Skipping for request records, multiple fallback options are provided herein in case of probable faults, which makes the system highly self-sufficient. For instance, if the techniques herein know there is an error preventing provisioning, then particular requests may be placed in a skipped queue to be retried later, notably keeping any successfully provisioned resources during the retry period. For example, assume that a request is to provision 10 VMs, and 5 are successfully procured but 5 are skipped. As such, the techniques herein can return the 5 successful VMs with a “pending” request response, and can await a state change on appropriate error categories (i.e., a cleared error-causing state) to then retry the “skipped” records to complete the request (notably without having to re-provision the originally successful VMs). Eventually, the request either completely succeeds, or else the additional resources are never provisioned (e.g., maximum number of retries, maximum length of time, etc.).

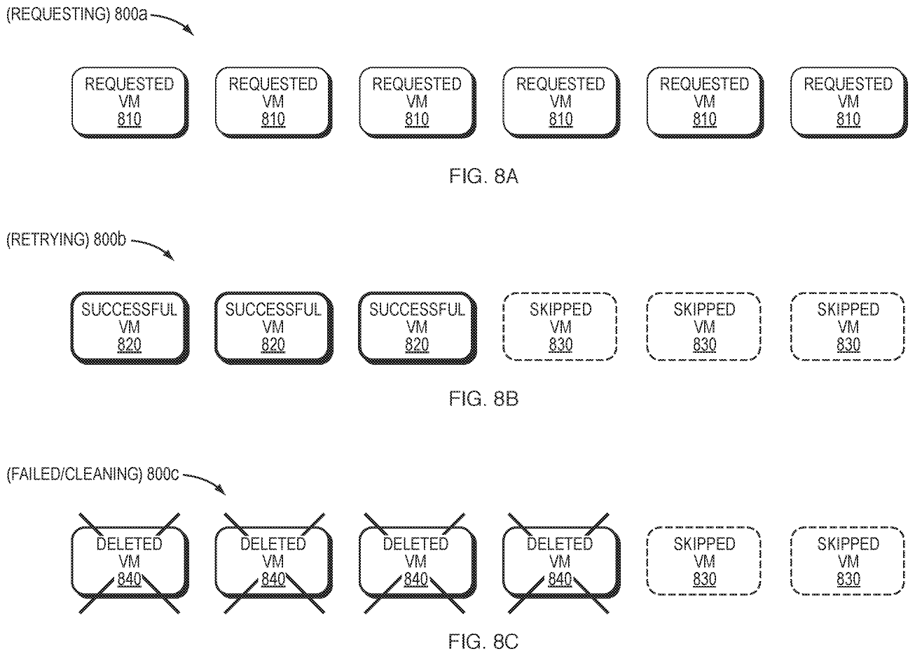

FIGS. 8A-8C illustrate this concept visually in a simplified manner. For instance, as shown in state 800a of FIG. 8A, there are 7 requested VMs 810. Next, in state 800b of FIG. 8B, there are now 3 successful VMs 820, and 3 skipped VMs 830. During this time, is a number of retry operations may be performed attempting to provision the skipped VMs, while persisting the currently procured infrastructure, but after a certain amount of time (e.g., a number of retries or a particular length of time, such as according to an SLA), any successful VMs from an incomplete request need to be cleaned up to release the online resources for other requests, accordingly. As such, as shown in state 800c of FIG. 8C, assuming only one additional VM was provisioned, those 4 successful VMs are now deleted VMs 840, and the request is deemed as failed.

Note that in one embodiment, the techniques herein may report the “partial success” to allow updating of the original request to simply keep the persisted online resources. That is, in the example above, the requestor may be notified that only 4 of the 6 requested VMs were provisioned, and at that time, the requestor may decide to update the request to keep the 4 allocated/provisioned VMs, rather than letting them be cleared. (In other words, some resources may be better than no resources.)

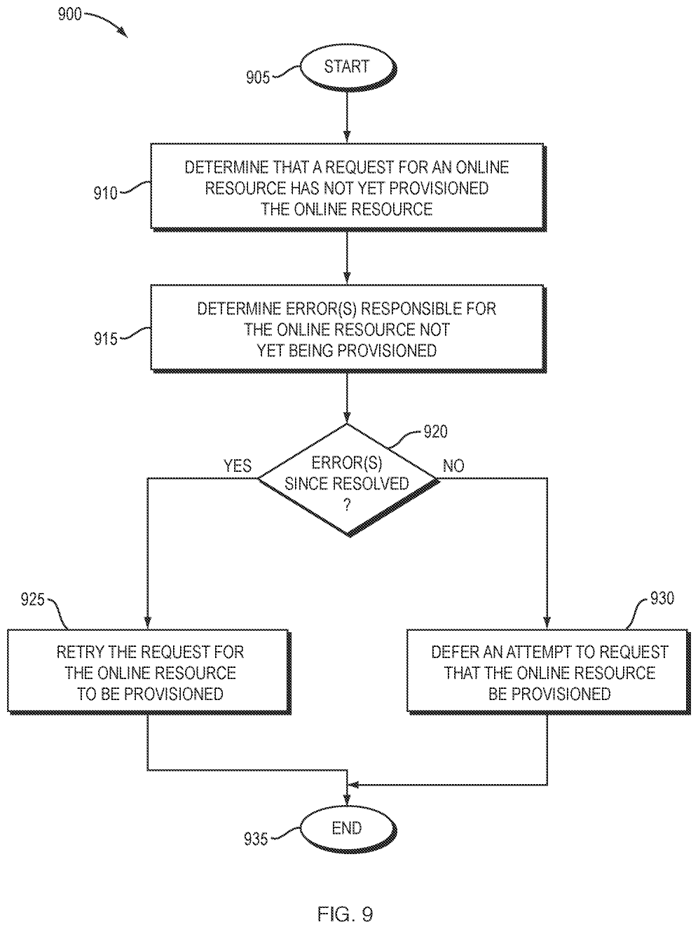

In closing, FIG. 9 illustrates an example simplified procedure for providing a smart retry policy for automated provisioning of online (e.g., cloud) resources in accordance with one or more embodiments described herein. For example, a non-generic, specifically configured device (e.g., device 200) may perform procedure 900 by executing stored instructions (e.g., process 248, such as a provisioning process). The procedure 900 may start at step 905, and continues to step 910, where, as described in greater detail above, the device (e.g., a provisioning device) determines that a request for an online resource (e.g., a VM) has not yet provisioned the online resource. For instance, as described above, the request for the online resource may not yet have provisioned the online resource due to a previously failed attempt to provision the online resource based on the one or more errors. Alternatively, the techniques herein may have anticipated a provisioning failure of the online resource in response to the request for the online resource, and may have prevented the request for the online resource from attempting to provision the online resource in response to anticipating a provisioning failure (i.e., the request for the online resource has not yet provisioned the online resource due to the preventing). In this instance, the techniques herein may have already been instrumenting is metrics regarding a plurality of possible errors, where, as described above, anticipating provisioning failures is based on the metrics being indicative of an error condition regarding the online resource likely being present.

In step 915, the techniques herein continue by determining one or more errors responsible for the online resource not yet being provisioned, and then in step 920 determining whether the one or more errors have since been resolved. For instance, determining whether the one or more errors have since been resolved may be based on a scheduled periodic retry operation, as described above. In one embodiment, the techniques herein instrument metrics regarding a plurality of possible errors, where determining whether the one or more errors have since been resolved is based on the metrics being indicative of an error condition no longer being present.

Note that as described above, in certain embodiments the techniques herein may configure a plurality of possible error categories for a given implementation, where the one or more errors responsible for the online resource not yet being provisioned fall into one or more respective error categories of the plurality of possible error categories (e.g., platform errors, quota exhaustion errors, service API errors, network-bound errors, security errors, etc.). In this manner, determining whether the one or more errors have since been resolved may thus be based on determining whether the one or more respective error categories have since been resolved.

In step 925, in response to the one or more errors having since been resolved, the techniques herein retry the request for the online resource to be provisioned, as detailed above.

On the other hand, in step 930, in response to the one or more errors remaining unresolved, the techniques herein correspondingly defer an attempt to request that the online resource be provisioned, as also detailed above.

The simplified procedure 900 may then end in step 935, notably with the ability to continue retrying and/or deferring until a successful provisioning operation completes, or until the retrying is limited to a maximum number of retries or the deferring is limited to a maximum length of time.

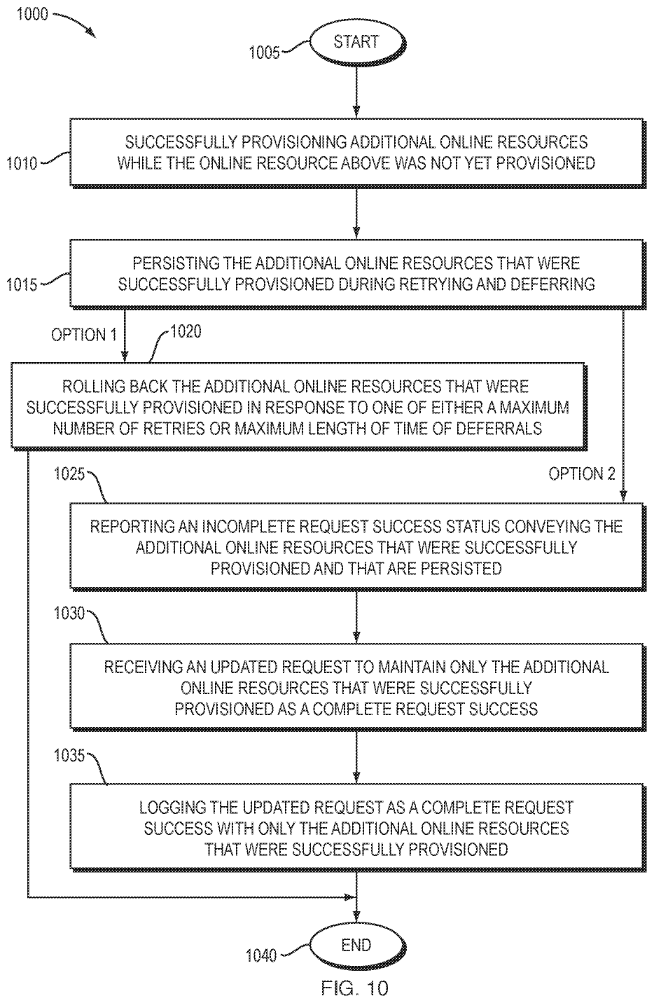

In addition, FIG. 10 illustrates another example simplified procedure for providing a smart retry policy for automated provisioning of online (e.g., cloud) resources in accordance with one or more embodiments described herein, particularly regarding partially successful requests. For example, the procedure 1000 may start at step 1005, and continues to step 1010, where the request for the online resource further requested additional online resources, and where one or more of the additional online resources were successfully provisioned while the online resource was not yet provisioned.

As such, as detailed above, in step 1015 the techniques herein may persist the one or more additional online resources that were successfully provisioned during the retrying and deferring of FIG. 9 above.

In a first “option 1” (a first embodiment), in step 1020 the techniques herein may then roll back the one or more additional online resources that were successfully provisioned in response to one of either a maximum number of retries or maximum length of time of deferrals.

Alternatively, in a second “option 2” (a second embodiment), the techniques herein may report an incomplete request success status conveying the one or more additional online resources that were successfully provisioned and that are persisted in step 1025, in response to which the device may then receive, in step 1030 an updated request to maintain only the one or more additional online resources that were successfully provisioned as a complete request success. As such, in step 1035, the techniques herein may log the updated request as a complete request success with only the one or more additional online resources that were successfully provisioned, as mentioned above.

The simplified procedure 1000 may then end in step 1040, accordingly.

Other steps may also be included generally within procedures 900 and/or 1000. For example, such steps (or, more generally, such additions to steps already specifically is illustrated above), may include: anticipating provisioning failures; instrumenting metrics; limiting retries/deferrals; configuring error categories (buckets); reporting various information (e.g., the one or more errors, the retrying, the deferring, additional online resources that were successfully provisioned, etc.); and so on.

It should be noted that while certain steps within the procedures above may be optional as described above, the steps shown in FIGS. 4-7 and 9-10 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures above are described separately, certain steps from each procedure may be incorporated into each other procedure, and the procedures are not meant to be mutually exclusive.

The techniques described herein, therefore, provide for smart retry policies for automated provisioning of online (e.g., cloud) resources. In particular, the techniques herein create a better user experience (e.g., UI with minimal errors, seamless procurement, no manual intervention, persisting existing Infrastructure on failures, etc.), better product team experience (e.g., preventive monitoring, zero downtime, improved instrumentation, minimized customer cases, etc.), better resource utilization (e.g., increased predictability, automatic clean-up of stale resources/VMs, cost effectiveness, etc.), and so on. The techniques herein also allow for a more self-sufficient system, with intelligent provisioning, better speed, and higher availability.

Contrary to existing transient fault handling solutions, the techniques herein provide precaution notifications and configuring of the custom error buckets for the cloud platform, as well as the ability to persist existing infrastructure on failures (e.g., only retrying procurement of the failed resources) and intelligent provisioning to automate the clean-up of stale resources. In addition, unlike conventional solutions, the techniques herein are directed to performing a “smart retry” operation when provisioning online resources (e.g., VMs), where, in one embodiment, the techniques herein determine why a particular resource procurement failed (an “error category”), and then instrument in order to determine that the error category has resolved before attempting the retry operation. In another embodiment, in particular, the techniques herein can also predict when a procurement task would initially fail, and can prevent the initial attempt to save resources, until it is likely that the task would be successful.

In still further embodiments of the techniques herein, a business impact of the online resource provisioning can also be quantified. That is, because of issues related to specific applications/processes (e.g., lost traffic, slower servers, overloaded network links, etc.), various corresponding business transactions may have been correspondingly affected for those applications/processes (e.g., online purchases were delayed, page visits were halted before fully loading, user satisfaction or dwell time decreased, etc.), while other processes (e.g., on other network segments or at other times) remain unaffected. The techniques herein, therefore, can correlate the online resource provisioning with various business transactions in order to better understand the effect on the business transactions, accordingly.

Illustratively, the techniques described herein may be performed by hardware, software, and/or firmware, such as in accordance with the illustrative online resource provisioning process 248, which may include computer executable instructions executed by the processor 220 to perform functions relating to the techniques described herein, e.g., in conjunction with corresponding processes of other devices in the computer network as described herein (e.g., on network agents, controllers, computing devices, servers, etc.). In addition, the components herein may be implemented on a singular device or in a distributed manner, in which case the combination of executing devices can be viewed as their own singular “device” for purposes of executing the process 248.

According to the embodiments herein, a method herein may comprise:

determining, by a device, that a request for an online resource has not yet provisioned the online resource; determining, by the device, one or more errors responsible for the online resource not yet being provisioned; determining, by the device, whether the one or more errors have since been resolved; retrying, by the device and in response to the one or is more errors having since been resolved, the request for the online resource to be provisioned; and deferring, by the device and in response to the one or more errors remaining unresolved, an attempt to request that the online resource be provisioned.

In one embodiment, the request for the online resource further requested additional online resources, and wherein one or more of the additional online resources were successfully provisioned while the online resource was not yet provisioned, and the method further comprises: persisting the one or more additional online resources that were successfully provisioned during retrying and deferring. In one embodiment, the method further comprises: rolling back the one or more additional online resources that were successfully provisioned in response to one of either a maximum number of retries or maximum length of time of deferrals. In one embodiment, the method further comprises: reporting an incomplete request success status conveying the one or more additional online resources that were successfully provisioned and that are persisted; receiving an updated request to maintain only the one or more additional online resources that were successfully provisioned as a complete request success; and logging the updated request as a complete request success with only the one or more additional online resources that were successfully provisioned.

In one embodiment, the method further comprises: configuring a plurality of possible error categories for a given implementation, wherein the one or more errors responsible for the online resource not yet being provisioned fall into one or more respective error categories of the plurality of possible error categories; and wherein determining whether the one or more errors have since been resolved is based on determining whether the one or more respective error categories have since been resolved. In one embodiment, the plurality of possible error categories are selected from a group consisting of: platform errors; quota exhaustion errors; service application programming interface (API) errors; network-bound errors; and security errors.

In one embodiment, the method further comprises: anticipating a provisioning failure of the online resource in response to the request for the online resource; and preventing the request for the online resource from attempting to provision the online is resource in response to anticipating a provisioning failure, wherein the request for the online resource has not yet provisioned the online resource due to the preventing. In one embodiment, the method further comprises: instrumenting metrics regarding a plurality of possible errors, wherein anticipating a provisioning failure is based on the metrics being indicative of an error condition regarding the online resource likely being present.

In one embodiment, the request for the online resource has not yet provisioned the online resource due to a previously failed attempt to provision the online resource based on the one or more errors.

In one embodiment, the method further comprises: limiting the retrying to a maximum number of retries; and limiting the deferring to a maximum length of time.

In one embodiment, determining whether the one or more errors have since been resolved is based on a scheduled periodic retry operation.

In one embodiment, the method further comprises: instrumenting metrics regarding a plurality of possible errors, wherein determining whether the one or more errors have since been resolved is based on the metrics being indicative of an error condition no longer being present.

In one embodiment, the online resource is a virtual machine.

In one embodiment, the method further comprises: reporting one or more of: the one or more errors; the retrying; the deferring; and one or more additional online resources that were successfully provisioned.

According to the embodiments herein, a tangible, non-transitory, computer-readable medium herein may have computer-executable instructions stored thereon that, when executed by a processor on a computer, may cause the computer to perform a method comprising: determining that a request for an online resource has not yet provisioned the online resource; determining one or more errors responsible for the online resource not yet being provisioned; determining whether the one or more errors have since been resolved; retrying, in response to the one or more errors having since been resolved, the request for the online resource to be provisioned; and deferring, in is response to the one or more errors remaining unresolved, an attempt to request that the online resource be provisioned.

Further, according to the embodiments herein an apparatus herein may comprise: one or more network interfaces to communicate with a network; a processor coupled to the network interfaces and configured to execute one or more processes; and a memory configured to store a process executable by the processor, the process, when executed, configured to: determine that a request for an online resource has not yet provisioned the online resource; determine one or more errors responsible for the online resource not yet being provisioned; determine whether the one or more errors have since been resolved; retry, in response to the one or more errors having since been resolved, the request for the online resource to be provisioned; and defer, in response to the one or more errors remaining unresolved, an attempt to request that the online resource be provisioned.

While there have been shown and described illustrative embodiments above, it is to be understood that various other adaptations and modifications may be made within the scope of the embodiments herein. For example, while certain embodiments are described herein with respect to certain types of networks in particular, the techniques are not limited as such and may be used with any computer network, generally, in other embodiments. Moreover, while specific technologies, protocols, and associated devices have been shown, such as Java, TCP, IP, and so on, other suitable technologies, protocols, and associated devices may be used in accordance with the techniques described above. In addition, while certain devices are shown, and with certain functionality being performed on certain devices, other suitable devices and process locations may be used, accordingly. That is, the embodiments have been shown and described herein with relation to specific network configurations (orientations, topologies, protocols, terminology, processing locations, etc.). However, the embodiments in their broader sense are not as limited, and may, in fact, be used with other types of networks, protocols, and configurations.

Moreover, while the present disclosure contains many other specifics, these is should not be construed as limitations on the scope of any embodiment or of what may be claimed, but rather as descriptions of features that may be specific to particular embodiments of particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

1. A method, comprising:
determining, by a device, that a request for an online resource has not yet provisioned the online resource;
determining, by the device, one or more errors responsible for the online resource not yet being provisioned, the one or more errors being associated with an error condition;
determining, by the device, whether the one or more errors have since been resolved;
retrying, by the device and in response to the one or more errors having since been resolved, the request for the online resource to be provisioned;
deferring, by the device and in response to the one or more errors remaining unresolved, an attempt to request that the online resource be provisioned; and
instrumenting metrics regarding a plurality of possible errors, wherein the determining of whether the one or more errors have since been resolved is based on the metrics indicating that the error condition is no longer present.

2. The method as in claim 1, wherein the request for the online resource further requested additional online resources, and wherein one or more of the additional online resources were successfully provisioned while the online resource was not yet provisioned, the method further comprising:
persisting the one or more additional online resources that were successfully provisioned during retrying and deferring.

3. The method as in claim 2, further comprising:
rolling back the one or more additional online resources that were successfully provisioned in response to one of either a maximum number of retries or maximum length of time of deferrals.

4. The method as in claim 2, further comprising:
reporting an incomplete request success status conveying the one or more additional online resources that were successfully provisioned and that are persisted;
receiving an updated request to maintain only the one or more additional online resources that were successfully provisioned as a complete request success; and
logging the updated request as a complete request success with only the one or more additional online resources that were successfully provisioned.

5. The method as in claim 1, further comprising:
configuring a plurality of possible error categories for a given implementation, wherein the one or more errors responsible for the online resource not yet being provisioned fall into one or more respective error categories of the plurality of possible error categories;
wherein determining whether the one or more errors have since been resolved is based on determining whether the one or more respective error categories have since been resolved.

6. The method as in claim 5, wherein the plurality of possible error categories are selected from a group consisting of: platform errors; quota exhaustion errors; service application programming interface (API) errors; network-bound errors; and security errors.

7. The method as in claim 1, further comprising:
anticipating a provisioning failure of the online resource in response to the request for the online resource; and
preventing the request for the online resource from attempting to provision the online resource in response to anticipating a provisioning failure, wherein the request for the online resource has not yet provisioned the online resource due to the preventing.

8. The method as in claim 7, wherein anticipating the provisioning failure is based on the metrics being indicative of an error condition regarding the online resource likely being present.

9. The method as in claim 1, wherein the request for the online resource has not yet provisioned the online resource due to a previously failed attempt to provision the online resource based on the one or more errors.

10. The method as in claim 1, further comprising:
limiting the retrying to a maximum number of retries; and
limiting the deferring to a maximum length of time.

11. The method as in claim 1, wherein determining whether the one or more errors have since been resolved is based on a scheduled periodic retry operation.

12. (canceled)

13. The method as in claim 1, wherein the online resource is a virtual machine.

14. The method as in claim 1, further comprising:
reporting one or more of: the one or more errors; the retrying; the deferring; and one or more additional online resources that were successfully provisioned.

15. A tangible, non-transitory, computer-readable medium having computer-executable instructions stored thereon that, when executed by a processor on a computer, cause the computer to perform a method comprising:
determining that a request for an online resource has not yet provisioned the online resource;
determining one or more errors responsible for the online resource not yet being provisioned, the one or more errors being associated with an error condition;
determining whether the one or more errors have since been resolved;
retrying, in response to the one or more errors having since been resolved, the request for the online resource to be provisioned;
deferring, in response to the one or more errors remaining unresolved, an attempt to request that the online resource be provisioned; and
instrumenting metrics regarding a plurality of possible errors, wherein the determining of whether the one or more errors have since been resolved is based on the metrics indicating that the error condition is no longer present.

16. The computer-readable medium as in claim 15, wherein the request for the online resource further requested additional online resources, and wherein one or more of the additional online resources were successfully provisioned while the online resource was not yet provisioned, the method further comprising:
persisting the one or more additional online resources that were successfully provisioned during retrying and deferring.

17. The computer-readable medium as in claim 16, wherein the method further comprises:
rolling back the one or more additional online resources that were successfully provisioned in response to one of either a maximum number of retries or maximum length of time of deferrals.

18. The computer-readable medium as in claim 15, wherein the method further comprises:
configuring a plurality of possible error categories for a given implementation, wherein the one or more errors responsible for the online resource not yet being provisioned fall into one or more respective error categories of the plurality of possible error categories;
wherein determining whether the one or more errors have since been resolved is based on determining whether the one or more respective error categories have since been resolved.

19. The computer-readable medium as in claim 15, wherein the method further comprises:
anticipating a provisioning failure of the online resource in response to the request for the online resource; and
preventing the request for the online resource from attempting to provision the online resource in response to anticipating a provisioning failure, wherein the request for the online resource has not yet provisioned the online resource due to the preventing.

20. An apparatus, comprising:
one or more network interfaces to communicate with a network;
a processor coupled to the network interfaces and configured to execute one or more processes; and
a memory configured to store a process that is executable by the processor, the process, when executed, configured to:
determine that a request for an online resource has not yet provisioned the online resource;
determine one or more errors responsible for the online resource not yet being provisioned, the one or more errors being associated with an error condition;
determine whether the one or more errors have since been resolved;
retry, in response to the one or more errors having since been resolved, the request for the online resource to be provisioned;
defer, in response to the one or more errors remaining unresolved, an attempt to request that the online resource be provisioned; and
instrument metrics regarding a plurality of possible errors, wherein the apparatus determines whether the one or more errors have since been resolved based on the metrics indicating that the error condition is no longer present.
